(19) United States
(12) Patent Application Publication
(10) Pub. No.: US 2005/0047981 A1
(43) Pub. Date: Mar. 3, 2005

(54) Process and apparatus for treating ammonia-containing waste water

(76) Inventors: Hirofumi Kikkawa, Kure-shi (JP); Yasuyoshi Kato, Kure-shi (JP); Shigehito Takamoto, Kure-shi (JP); Takanori Nakamoto, Kure-shi (JP)

Correspondence Address: Richard J Minnich;Fay Sharpe Fagan Minnich & McKee, 1100 Superior Avenue, 7th Floor, Cleveland, OH, 44114, US

(21) Appl. No.: 10/343,891

(22) PCT Filed: Mar. 30, 2001
(86) PCT No.: PCT/JP01/02805

(30) Foreign Application Priority Data
Aug. 10, 2000 (JP) 2000-243007
Aug. 10, 2000 (JP) 2000-243466

(51) Int. Cl. C01B 21/00

(52) U.S. Cl. 423/235

(57) ABSTRACT

Disclosed are methods and apparatuses for treating an ammonia-containing effluent in which the amount of hazardous substances such as NOx formed at the time of starting the operation of the apparatus or even at the time when the concentration of ammonia (NH₃) in the gas to be subjected to an NH₃ decomposing step (described below) was changed is extremely small; in which method an NH₃-containing effluent A and vapor (carrier gas) C are contacted in stripping tower 7 to transfer the NH₃ from the effluent to a gas phase, a gas containing the NH₃ stripped in the tower is heated with pre-heater 1 and then contacted with catalyst 13 to decompose the NH₃ into nitrogen and water, the concentration of the NOx (or N₂O) contained in the gas resulted at the NH₃ decomposing step is determined, and one or more of parameters (a) the amount of the effluent to be supplied to the stripping step, (b) the concentration of the NH₃ contained in the effluent, and (c) the flow rate of the NH₃-containing gas contacted with the catalyst (when the N₂O concentration was determined, one or more of (e′) the flow rate of the carrier gas, (f′) the amount of a gas such as air to be added to the NH₃-containing gas, and (g′) the amount of a part of the gas resulted at the NH₃ decomposing step and to be circulated) are adjusted responding to the concentration of the NOx (or N₂O).

### TECHNICAL FIELD

The present invention relates to a method and an apparatus for treating an effluent (waste water) containing ammonia (NH₃). More specifically, the present invention relates to a method and an apparatus for treating an NH₃-containing effluent by which method or apparatus the ammonia contained in the effluent discharged especially from a thermal power plant is efficiently converted into nitrogen (N₂) and water (H₂O) to make the ammonia harmless by a stripping method.

### BACKGROUND ART

In recent years, there has been a growing concern to the conservation of global environment, and regulations against over-fertilization of sea areas have been enforced. Thus, the development of a new technology for removing nitrogen from an effluent has been sought. In answer to such request, the removal of the nitrogen contained in an effluent has been conducted from some time ago mainly by the following methods:
1) Biological denitrification method: Method in which an organic nitrogen contained in water is converted into an inorganic nitrogen to render the organic nitrogen harmless by using a bacterium.
2) Discontinuous NH₃ decomposition method using chlorine: Method in which NH₃ is oxidized to decompose by using sodium hypochlorite.
3) Ion exchange method: Method in which NH₃ is adsorbed on a zeolite through an ion exchange.
4) Ammonia stripping method: Method in which the NH₃ contained in an NH₃-containing effluent is diffused or evaporated from the effluent into the atmosphere by using air or steam as carrier gas.

When the BOD (biochemical oxygen demand) of an effluent is high, biological denitrification method 1) described above is used. On the other hand, in the case where an effluent in which most of nitrogen is in a form of ammonia nitrogen such as ammonia and ammonium ion is to be treated, for instance, when an effluent from a process in a chemical factory or an effluent once-subjected to a post-treatment is the object of the treatment, method 2), 3) or 4) is used.

However, the conventional methods described above have the problems as follows:

In the method 1), the size of a reaction bath necessary for the treatment becomes large since the rate of a biological reaction is slow, and thus a large space comes to be required for placing the reaction bath. Besides, the method 1) raises a problem that excess amount of a sludge is produced. Method 2) causes problems that a treatment of remaining chlorine becomes necessary and organic chlorine compounds are formed, since the addition of sodium hypochlorite in an amount more than that stoichio-metrically required is necessary for completely removing the ammonia. In the method 3), a secondary effluent containing ammonium ion at a high concentration is produced at the time of regenerating a used zeolite and thus a treatment of the secondary effluent becomes necessary. Further, the method 4) has a problem of causing a secondary pollution, since the NH₃ contained in an effluent is first transferred into a gas phase and then the NH₃-containing gas is diffused or emitted into the atmosphere.

Among the methods described above, method 4) is advantageous compared with other methods since the treatment of an effluent is comparatively simple and the costs of equipments and operations are small. Accordingly, a combination in which the ammonia stripping method 4) is performed in combination with another method which can be used for oxidatively decompose the NH₃ contained in the gas resulting at the stripping at a high concentration by using a catalyst, to make the NH₃ originally contained in the effluent harmless as the result of the combination, has been adopted even in current night-soil treatment facilities.

However, in such conventional stripping and catalytically oxidizing process, it is necessary to install a catalyst tower for reducing NOx in addition to a catalyst tower for oxidizing NH₃ since a large quantity of NOx is formed at the time of the oxidation of NH₃. Further, according to the investigations by the present inventors, it has been found out that a large quantity of N₂O is also produced in this process at the time of oxidizing the NH₃. Still further, there is a problem that the concentration of N₂O in the gas at the outlet of a catalyst tower increases when the concentration of NH₃ in an effluent or the amount of an effluent to be supplied into a stripping tower was varied. Like CO₂, N₂O is a substance contributing to the global warming. Accordingly, it is dangerous to the global environment that a large quantity of N₂O is diffused into the atmosphere, to the same extent as NH₃ is diffused as it is. Thus, the diffusion of N₂O is also undesirable. Besides, there is a problem that the concentration of NOx in the gas at the outlet of a catalyst tower for reducing NOx increases at the time when the operation of the apparatus was started or when the concentration of NH₃ in the gas resulting at the stripping was varied.

### DISCLOSURE OF THE INVENTION

A subject of the present invention is to provide a method for treating an NH₃-containing effluent in which method the amount of secondary pollution substances such as N₂O and NOx incidentally formed is decreased and the amount of utilities such as a steam to be used is reduced.

Another subject of the present invention is to provide a method and an apparatus for treating an NH₃-containing effluent in which method and apparatus the concentration of the N₂O in the gas at the outlet of a catalyst tower is not increased even if the concentration of NH₃ in an effluent and the amount of an effluent to be supplied into a stripping tower was varied, and the amount of hazardous substances formed is extremely small.

In order to achieve the subjects described above, the present invention is summarized as follows:

(1) A method for treating an NH₃-containing effluent comprising a stripping step in which the NH₃ contained in the NH₃-containing effluent is transferred from the effluent into a gas phase by contacting the effluent with a carrier gas, a step for decomposing the NH₃ into nitrogen and water by contacting the gas resulted at the stripping step and containing the NH₃ with a catalyst used for decomposing NH₃, at a prescribed temperature, a step for determining the concentration of the nitrogen oxides (NOx) contained in the gas resulted at the NH₃ decomposing step, and a step for adjusting one or more of the following parameters:
(a) the amount of the NH₃-containing effluent to be supplied to the stripping step,
(b) the concentration of the NH₃ contained in the NH₃-containing effluent, and
(c) the flow rate of the NH₃-containing gas to be contacted with the catalyst
   so that the determined value of the concentration of the NOx contained in the gas resulted at the NH₃ decomposing step becomes lower than a prescribed value.

(2) The method for treating an NH₃-containing effluent recited in paragraph (1) above wherein the temperatures of the layer of the catalyst at plural points located along the direction of the gas flow at the NH₃ decomposing step are determined instead of determining the concentration of the NOx contained in the gas resulted at the NH₃ decomposing step, and one or more of the parameters (a), (b), and (c) recited in paragraph (1) above are adjusted responding to the difference between the determined temperatures instead of the concentration of the NOx.

(3) The method for treating an NH₃-containing effluent recited in paragraph (1) or (2) above wherein the catalyst used for decomposing NH₃ comprises a first component having an activity of reducing NOx with NH₃ and a second component having an activity of forming NOx from NH₃.

(4) The method for treating an NH₃-containing effluent recited in paragraph (1) or (2) above wherein the catalyst used for decomposing NH₃ comprises, as a first component, an oxide of titanium (Ti) and an oxide of one or more elements selected from the group consisting of tungsten (W), vanadium (V), and molybdenum (Mo), and, as a second component, a silica, zeolite, and/or alumina having one or more noble metals selected from the group consisting of platinum (Pt), iridium (Ir), rhodium (Rh), and palladium (Pd) supported thereon.

(5) The method for treating an NH₃-containing effluent recited in paragraph (1) above wherein the catalyst used for decomposing NH₃ is a zeolite or comprises, as a main component, a zeolite.

(6) The method for treating an NH₃-containing effluent recited in paragraph (1) above wherein the method further comprises a step for removing ammonia from a part of the gas resulted at the NH₃ decomposing step after the part of the gas was discharged outside the system.

(7) A method for treating an NH₃-containing effluent comprising a stripping step in which the NH₃ contained in the NH₃-containing effluent is transferred from the effluent into a gas phase by contacting the effluent with a carrier gas, a step for decomposing the NH₃ into nitrogen and water by contacting the gas resulted at the stripping step and containing the NH₃ with a catalyst used for decomposing NH₃, at a prescribed temperature, a step for determining the concentration of the N₂O contained in the gas resulted at the NH₃ decomposing step, and a step for adjusting the flow rate of the gas in the layer of the catalyst or adjusting the contact time of the gas with the catalyst in the layer so that the determined value of the concentration of the N₂O contained in the gas resulted at the NH₃ decomposing step becomes lower than a prescribed value.

(8) The method for treating an NH₃-containing effluent recited in paragraph (7) above wherein, as a method for adjusting the flow rate of the gas in the catalyst layer, one of the following methods is used:
(e) a method in which the flow rate of the carrier gas at the step for transferring the NH₃ contained in the NH₃-containing effluent into the gas phase is adjusted,
(f) a method in which a gas such as air is added to the NH₃-containing gas resulted at the step for transferring the NH₃ contained in the NH₃-containing effluent into the gas phase, and
(g) a method in which a part of the gas resulted at the NH₃ decomposing step is circulated to the catalyst layer.

(9) The method for treating an NH₃-containing effluent recited in paragraph (8) above wherein the temperatures of the layer of the catalyst at plural points located along the direction of the gas flow at the NH₃ decomposing step are determined instead of determining the concentration of the N₂O contained in the gas resulted at the NH₃ decomposing step, and one or more of the methods (e), (f), and (g) recited in paragraph (8) above are conducted responding to the difference between the determined temperatures instead of the concentration of the N₂O.

(10) The method for treating an NH₃-containing effluent recited in paragraph (7) or (8) above wherein the catalyst used for decomposing NH₃ comprises a first component having an activity of reducing NOx with NH₃ and a second component having an activity of forming NOx from NH₃.

(11) The method for treating an NH₃-containing effluent recited in paragraph (7) or (8) above wherein the catalyst used for decomposing NH₃ comprises, as a first component, an oxide of titanium (Ti) and an oxide of one or more elements selected from the group consisting of tungsten (W), vanadium (V), and molybdenum (Mo), and, as a second component, a silica, zeolite, and/or alumina having one or more noble metals selected from the group consisting of platinum (Pt), iridium (Ir), rhodium (Rh), and palladium (Pd) supported thereon.

(12) The method for treating an NH₃-containing effluent recited in paragraph (7) or (8) above wherein the catalyst used for decomposing NH₃ is a zeolite or comprises, as a main component, a zeolite.

(13) The method for treating an NH₃-containing effluent recited in paragraph (7) or (8) above wherein the method further comprises a step for removing ammonia from a part of the gas resulted at the NH₃ decomposing step after the part of the gas was discharged outside the system.

(14) An apparatus for treating an NH₃-containing effluent comprising a stripping device in which the NH₃ contained in the NH₃-containing effluent is transferred from the effluent into a gas phase by contacting the effluent with a carrier gas, a device for decomposing the NH₃ into nitrogen and water by contacting the gas resulted in the stripping device and containing the NH₃ with a catalyst used for decomposing NH₃, at a prescribed temperature, a device for determining the concentration of the nitrogen oxides (NOx) contained in the gas resulted in the NH₃ decomposing device, and a device for adjusting one or more of the following parameters:
(a) the amount of the NH₃-containing effluent to be supplied to the stripping step,
(b) the concentration of the NH₃ contained in the NH₃-containing effluent, and
(c) the flow rate of the NH₃-containing gas to be contacted with the catalyst
   so that the determined value of the concentration of the NOx contained in the gas resulted in the NH₃ decomposing device becomes lower than a prescribed value.

(15) An apparatus for treating an NH₃-containing effluent comprising a stripping device in which the NH₃ contained in the NH₃-containing effluent is transferred from the effluent into a gas phase by contacting the effluent with a carrier gas, a device for decomposing the NH₃ into nitrogen and water by contacting the gas resulted in the stripping device and containing the NH₃ with a catalyst used for decomposing NH₃, at a prescribed temperature, a device for determining the concentration of the N₂O contained in the gas resulted in the NH₃ decomposing device, and a device for adjusting the flow rate of the gas in the layer of the catalyst or the contact time of the gas with the catalyst in the layer so that the determined value of the concentration of the N₂O contained in the gas resulted in the NH₃ decomposing device becomes lower than a prescribed value.

As a specific example of the catalyst used in the present invention and comprising a first component having an activity of reducing nitrogen oxides with NH₃ and a second component having an activity of forming nitrogen oxides (NOx), catalysts comprising, as a first component, an oxide of titanium (Ti) and an oxide of one or more elements selected from the group consisting of tungsten (W), vanadium (V), and molybdenum (Mo), and, as a second component, a silica, zeolite, and/or alumina having one or more noble metals selected from the group consisting of platinum (Pt), iridium (Ir), rhodium (Rh), and palladium (Pd) supported thereon can be mentioned. Besides, a catalyst substantially consisting of a zeolite or comprising, as a main component, a zeolite has an effect of considerably reducing the formation of NOx or N₂O.

By changing the ratio-of the first component to the second component in the catalyst described above, it is possible to adjust the concentrations of NH₃ and NOx in the gas resulted in the NH₃ decomposing step. For instance, when the ratio of the second component was reduced, the ratio of decomposition of NH₃ is slightly lowered, but the concentration of NOx in the resulting gas is considerably reduced.

In order to transfer the NH₃ contained in an NH₃-containing effluent from the effluent into a gas phase, a method in which the NH₃ contained in the effluent is stripped into the gas phase, specifically, for example, (a) a method in which a carrier gas is blown into the effluent, and (b) a method in which the effluent is sprayed in a carrier gas are used. When the effluent has a pH of 10 or higher, the stripping is performed as it is. On the other hand, when the effluent has a pH of lower than 10, an alkali such as sodium hydroxide and calcium hydroxide (slaked lime) is first added to the effluent to make its pH 10 or higher, and then the effluent is contacted with air to diffuse or evaporate the NH₃ into the air by using the air as a carrier gas. As the carrier gas, a steam can be used in place of air. The term “carrier gas” as used herein generically means a gas which gas can diffuse or evaporate ammonia from the effluent.

An NH₃-containing gas is preheated just before the gas is introduced into a stripping tower or catalyst tower, when necessary. Preheating may be conducted by a usual method, for example, by heating with a burner or heat exchange with a gas at a high temperature such as a steam or a gas discharged from a catalyst-.device. When the gas is circulated in the method and apparatus of the present invention, it is preferable to use a procedure in which the composition of the gas, especially the concentration of oxygen in the gas is not changed. (As an example, therefore, a method using an indirect heat exchange is preferable.)

In the case where an NH₃ decomposing catalyst having a denitrating function is used, it is important to control the temperature of a catalyst layer placed within a catalyst tower in the range of 250 to 450° C., preferably in the range of 350 to 400° C. In the case where a zeolite type catalyst is used, it is preferable to maintain the temperature of a catalyst layer in the range of 450 to 600° C. In any case, it is satisfactory that a suitable temperature is selected based on the performances of a catalyst.

The term “NH₃-containing effluent” used herein means an effluent containing ammonia nitrogen, such as an effluent discharged from a drain treating plant or sewerage treating facility, and an effluent discharged from a dry type electrostatic precipitator or a wet type desulfurizing apparatus installed for removing combustion ashes or SOx contained in an exhaust gas discharged from a thermal power plant having a coal firing boiler or oil firing boiler. Also, the term “NH3-containing effluent” includes effluents which contain an nitrogen converted into ammonia nitrogen by a pretreatment, such as an effluent in which an organic nitrogen-originally contained in-the effluent was decomposed into strippable ammonia nitrogen by a general biological treatment, and an effluent containing NH₃ at a high concentration and discharged at the time of the regeneration of a zeolite in a conventional ion exchange method used in various fields of industry.

### BRIEF DESCRIPTION OF THE DRAWINGS

FIG. 1 is a diagram for illustrating an embodiment of the methods for treating an NH₃-containing effluent and the arrangements of devices in the apparatuses of the present invention.

FIG. 2 is a line graph showing experimental data relating to the apparatus shown in FIG. 1.

FIG. 3 is a line graph showing other experimental data relating to the apparatus shown in FIG. 1.

FIG. 4 is a diagram for illustrating another embodiment of the methods and the arrangements of devices in the apparatuses of the present invention.

FIG. 5 is a diagram for illustrating still another embodiment of the methods and the arrangements of devices in the apparatuses of the present invention.

FIG. 6 is a diagram for illustrating still another embodiment of the methods and the arrangements of devices in the apparatuses of the present invention.

FIG. 7 is a schematic diagram for illustrating the effects of a catalyst used in the present invention.

FIG. 8 is a diagram for illustrating still another embodiment of the methods and the arrangements of devices in the apparatuses of the present invention.

FIG. 9 is a line graph showing experimental data relating to the apparatus shown in FIG. 8.

FIG. 10 is a line graph showing other experimental data relating to the apparatus shown in FIG. 8.

FIG. 11 is a diagram for illustrating still another embodiment of the methods and the arrangements of devices in the apparatuses of the present invention.

FIG. 12 is a diagram for illustrating still another embodiment of the methods and the arrangements of devices in the apparatuses of the present invention.

FIG. 13 is a diagram for illustrating still another embodiment of the methods and the arrangements of devices in the apparatuses of the present invention.

FIG. 14 is a diagram for illustrating still another embodiment of the methods and the arrangements of devices in the apparatuses of the present invention.

FIG. 15 is a line graph showing experimental data relating to the apparatus shown in FIG. 14.

FIG. 16 is a line graph showing other experimental data relating to the apparatus shown in FIG. 14.

FIG. 17 is a diagram for illustrating still another embodiment of the methods and the arrangements of devices in the apparatuses of the present invention.

FIG. 18 is a diagram for illustrating still another embodiment of the methods and the arrangements of devices in the apparatuses of the present invention.

FIG. 19 is a diagram for illustrating still another embodiment of the methods and the arrangements of devices in the apparatuses of the present invention.

FIG. 20 is a diagram for illustrating still another embodiment of the methods and the arrangements of devices in the apparatuses of the present invention.

### BEST MODE FOR CARRYING OUT THE INVENTION

Now, the embodiments of the present invention are described in more detail with reference to drawings.

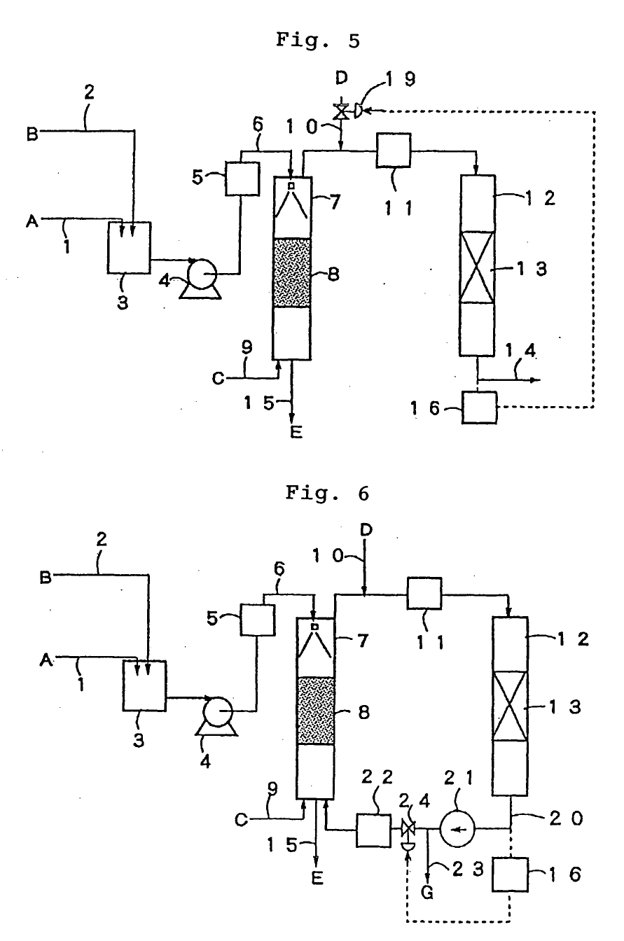

The model of a small pore in an NH₃ decomposing catalyst having a denitrating function and used in the present invention is shown in FIG. 7.

As demonstrated in FIG. 7, the pore has a structure in which micro-pores formed by (or inherently contained in) a porous silica exist at places within a relatively macro-pore formed by a component (first component) on the surface of which NO is reduced by NH₃, and ultramicro-particles of another component (second component) having an activity of forming NOx from NH₃ are supported on the surface of the silica. NH₃ diffuses within the macro-pore in a catalyst, the diffused NH₃ is oxidized on the second component to form NO according to the equation (1) described below, the NO collide with NH₃ adsorbed on the surface of the first component (which forms the macro-pore), in the course of diffusing outside the catalyst, and the NH₃ is reduced down to N₂ according to the equation (2) described below. As a whole, the NH₃ is changed as shown by equation (3) described below.
NH₃+5/4O₂→NO+3/2H₂O (1)
NH₃+NO+1/4O₂→N₂+3/2H₂O (2)
NH₃+3/4O₂→1/2N₂+3/2H₂O (3)

As described above, when an NH₃ decomposing catalyst having a denitrating function is used, it is possible to reduce NH₃ to N₂ while scarcely forming, as a final product, NO or N₂O which is generally considered to be formed during the process of forming NO, since the oxidizing reaction of NH₃ and the reducing reaction of formed NO with NH₃ proceed within the catalyst.

Besides, even when a zeolite is used, the amount of NO or N₂O incidentally formed is extremely small.

However, even in the case where such catalyst is used, a phenomenon in which the concentration of NO in the gas at the outlet of a catalyst tower becomes slightly high when the concentration of NH₃ in an effluent is high is observed. Although the reason for the phenomenon has not yet completely been cleared, it can be considered to be due to the fact that the reactions of the equations (1) and (2) are exothermic, and the temperature of the catalyst itself is varied when the concentration of NH₃ in the gas to be contacted with a catalyst changes. As a result of diligent investigations by the present inventors, it has now been found out that the means described below is effective to such a passing or transient increase of the concentration of NO in the gas at the outlet of a catalyst tower.

When the concentration of NOx in the gas at the outlet of a catalyst tower was determined and the determined value of the concentration of the NOx was found to be higher than a certain value, one or more of the following parameters are adjusted:
(a) the amount of an NH₃-containing effluent to be supplied to a stripping step,
(b) the concentration of the NH₃ contained in an NH₃-containing effluent, and
(c) the flow rate of an NH₃-containing gas to be contacted with a catalyst.

More specifically, the means described above is to decrease (a) the amount of an NH₃-containing effluent to be supplied, (b) the concentration of the NH₃ contained in an NH₃-containing effluent, or (c) the flow rate of an NH₃-containing gas to be contacted with a catalyst.

When (a) the amount of an NH₃-containing effluent to be supplied or (b) the concentration of the NH₃ contained in an NH₃-containing effluent was reduced, the concentration of NH₃ in the gas to be contacted with a catalyst is also decreased, and thus the temperature of the catalyst itself is stabilized earlier than usual. As the result, the concentration of the NOx in the gas at the outlet of a catalyst tower is also decreased. When the concentration of the NOx at the outlet of a catalyst tower became lower than a certain value, a prescribed amount of an effluent can be treated by gradually increasing (a) the amount of an NH₃-containing effluent to be supplied or (b) the concentration of the NH₃ contained in an NH₃-containing effluent while monitoring the concentration of the NOx in the gas at the outlet of a catalyst tower. Further, when the flow rate of an NH₃-containing gas to be contacted with a catalyst was reduced, the contact time of the gas with the catalyst becomes longer, and thus a prescribed amount of an effluent can be treated by gradually increasing (c) the flow rate of an NH₃-containing gas to be contacted with the catalyst while monitoring the concentration of the NOx.

Besides, in order to prevent the rise in the concentration of NOx in the gas at the outlet of a catalyst tower above a certain value, a method in which the gas is circulated to a stripping tower or to the inlet of a catalyst tower depending on the concentration of NOx in the gas at the outlet of a catalyst tower is also effective.

When such catalyst is used, the difference in the composition of a gas between before and after the reaction is that only the amounts of NH₃ and O₂ decrease, and N₂ and H₂O are formed as shown by the equation (3) described above. Since the concentration of NH₃ contained in a gas to be treated is usually a few thousands ppm, there is not a case where the chemical composition of the gas is largely changed by the reaction.

Thus, it becomes possible to circulate a part of the gas which was-subjected to the NH₃ decomposition treatment (hereinafter the gas is referred to as post-treatment gas), to a stripping tower as a part of a carrier gas by introducing air in an amount commensurate with the amount of oxygen consumed in the reaction, into a catalyst tower, and discharging an increased amount of the gas outside the system. Since the amount of the gas to be discharged outside the system becomes about a few tenths that in conventional methods by conducting such operation, an absolute amount of the gas discharged outside the system can be considerably reduced. Even in this case, when the concentration of Nox in the gas at the outlet of a catalyst tower became lower than a certain value, it is satisfactory to reduce the amount of the gas to be circulated, and eventually return all the gas into a previous gas flow while monitoring the concentration of the NOx in the gas at the outlet of the catalyst tower.

In this connection, it can consider determining the concentration of NH₃ in the gas at the outlet of a catalyst tower instead of the concentration of the NOx. However, it is difficult to accurately determine the concentration of NH₃ in the gas since NH₃ is ready to dissolve in water.

### FIRST EMODIMENT OF THE PRESENT INVENTION

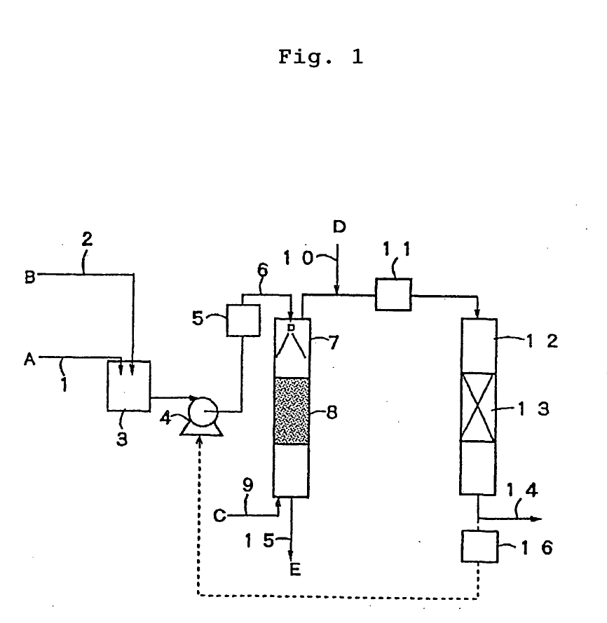

FIG. 1 is a diagram for illustrating a system of devices (hereinafter referred to as device system) used when a process of the present invention for treating an NH₃-containing effluent is applied to an effluent containing an ammonia nitrogen at a high concentration, for example, an effluent discharged from a thermal power plant.

As shown in FIG. 1, effluent A and alkali B are supplied to tank 3 through pipe 1 and pipe 2, respectively, mixed in tank 3, and then fed to pre-heater 5 with pump 4. The effluent A preheated with pre-heater 5 up to about 100° C. is supplied to a top portion of stripping tower 7 through pipe 6. Within stripping tower 7 is placed packing material 8, and steam C (including air) supplied as a carrier gas through pipe 9 connected to a bottom portion of the tower rises through stripping tower 7 while efficiently contacting in the tower with effluent A to obtain a gas containing ammonia at a high concentration. The concentration of NH₃ in the gas thus obtained is usually a few thousands to a few tens of thousands ppm. The gas obtained is introduced into catalyst tower 12 after diluted with air D supplied through pipe 10 when necessary and preheated up to a prescribed temperature with pre-heater 11 according to circumstances. The ammonia contained in the gas is oxidized to decompose into N₂ and H₂O on catalyst layer 13 placed in catalyst tower 12 and then discharged through pipe 14 into the atmosphere. A part of the gas is fed to NOx meter 16 and the concentration NOx in the gas is determined therewith.

Responding to the value determined by NOx meter 16, the flow rate of effluent A supplied with pump 4 to a top portion of stripping tower 7 is adjusted by means of a flow rate control line. From pipe 15 connected to a bottom portion of stripping tower 7, effluent E resulted by removing ammonia from effluent A is discharged. In this connection, the catalyst used in this embodiment comprises a first component having an activity of reducing nitrogen oxides with NH₃ and a second component having an activity of forming nitrogen oxides (NOx) from NH₃. Further, the reaction temperature in catalyst layer 13 at this time is usually 250 to 450° C. and preferably 350 to 400° C.

The examples in which a catalyst of the present invention was applied in the apparatus (device system) shown in FIG. 1 are described below.

### EXAMPLE 1

Ammonium paratungstate ((NH_{4 )}₁₀H₁₀.W₁₂O₄₆.6H₂O) in an amount of 2.5 kg and 2.33 kg of ammonium metavanadate were added to 67 kg of a slurry of metatitanic acid (TiO₂ content: 30 wt %, SO₄ content: 8 wt %) and mixed by using a kneader. The paste thus obtained was granulated, dried, and then calcined at 550° C. for 2 hours. The granules thus obtained were ground to obtain powders as a first component of a catalyst. The powders had a composition of Ti/W/V=91/5/4 (ratio of atoms).

On the other hand, 500 g of fine powders of silica (produced by Tomita Pharmaceuticals Co., Ltd.; trade name: Micon F) was added to 1 L of 1.33×10⁻² wt % of chloroplatinic acid (H₂[PtCl₆].6H₂O), evaporated to dryness on a sand bath, and then calcined at 500° C. for 2 hours in the air to prepare 0.01 wt % Pt.SiO₂ powders as a second component of the catalyst.

Next, 5.3 kg of silica.alumina type inorganic fibers and 17 kg of water were added to the mixture of 20 kg of the first component and 40.1 g of the second component, and kneaded to obtain a catalyst paste. Separately, a net-like product made of E glass fibers was impregnated with a slurry containing a titania, silica sol and polyvinyl alcohol, dried at 150° C., and cut into plural sheets to prepare catalyst substrates. Between two of the catalyst substrates (sheets) was held the catalyst paste described above and they were passed through press rollers to roll, thereby obtaining a plate-like product. After the plate-like product was air-dried in the atmosphere for 12 hours, it was calcined at 500° C. for 2 hours to obtain an NH₃ decomposing catalyst having a denitrating function. In the catalyst thus obtained, the ratio of the second component to the first component (the second component/the first component) was 0.2/99.8.

A test for treating an effluent was conducted by using the catalyst obtained in this example and the apparatus as shown in FIG. 1 under the conditions shown in Table 1.

However, when the reading of NOx meter 16 exceeded 5 ppm, the flow of effluent A supplied to a top portion of stripping tower 7 with pump 4 was once stopped and then the flow was controlled by an on-off switch.

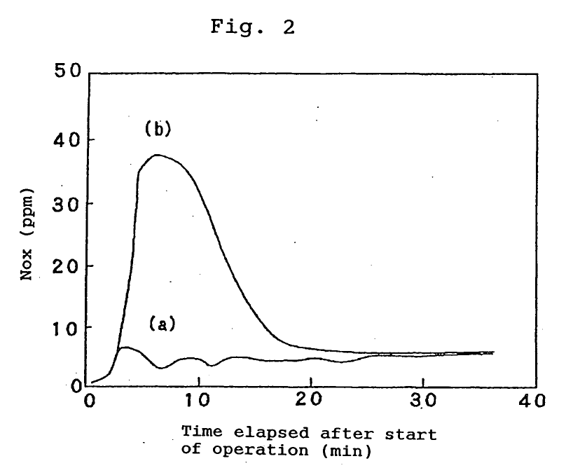

The relation between the concentration of NOx in the gas at the outlet of a catalyst tower and the time elapsed after the operation of the apparatus was started is shown by curve (a) in FIG. 2.

TABLE 1

| Item | Condition | |
|---|---|---|
| Rate of treating effluent | 1.6 | L/h |
| Amount of NH₄⁺ in effluent | 2,000 | mg/L |
| Gas flow rate at inlet of | 1.3 | m³/h |
| catalyst layer | | |
| Gas composition | NH₃: 3,000 ppm | |
| | H₂O: 28% | |
| | Air: | |
| | the remainder | |
| Temperature | 350° | C. |
| Areal velocity | 17 | m/h |

### COMPARATIVE EXAMPLE 1

A test for treating an effluent was conducted using the same apparatus and catalyst as in Example 1 under the same conditions as those shown in Table 1 with the exception that NOx meter 16 and the line for controlling the flow rate of effluent A were omitted. The results thus obtained are shown by curve (b) in FIG. 2.

From FIG. 2, it can be understood that the concentration of NOx in the gas at the outlet of a catalyst tower at the time when the operation of the apparatus was started in Example 1 is remarkably low compared with Comparative Example 1.

### EXAMPLE 2

A test for treating an effluent in case the concentration of NH₄⁺ in the effluent is suddenly changed was conducted by using the same catalyst and the apparatus as those used in Example 1.

However, when the reading of NOx meter 16 exceeded 10 ppm after the concentration of NH₄⁺ was suddenly increased, the flow of effluent A supplied to a top portion of stripping tower 7 with pump 4 was once stopped and then the flow was controlled by an on-off switch.

The relation between the concentration of NOx in the gas at the outlet of a catalyst tower and the time elapsed after the operation of the apparatus was started in this test is shown by curve (a) in FIG. 3.

### COMPARATIVE EXAMPLE 2

A test for treating an effluent was conducted by using the same apparatus as used in Comparative Example 1 under the same conditions as in Example 2. The results thus obtained are shown by curve (b) in FIG. 3.

As shown in FIG. 3, the concentration of NOx in the gas at the outlet of a catalyst tower at the time when the concentration of NH₄⁺ in an effluent was suddenly increased in Example 2 is considerably low compared with Comparative Example 2.

### SECOND EMBODIMENT OF THE PRESENT INVENTION

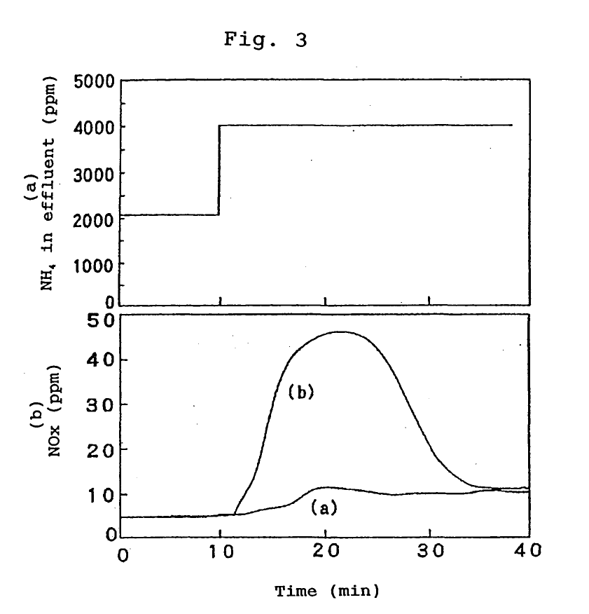

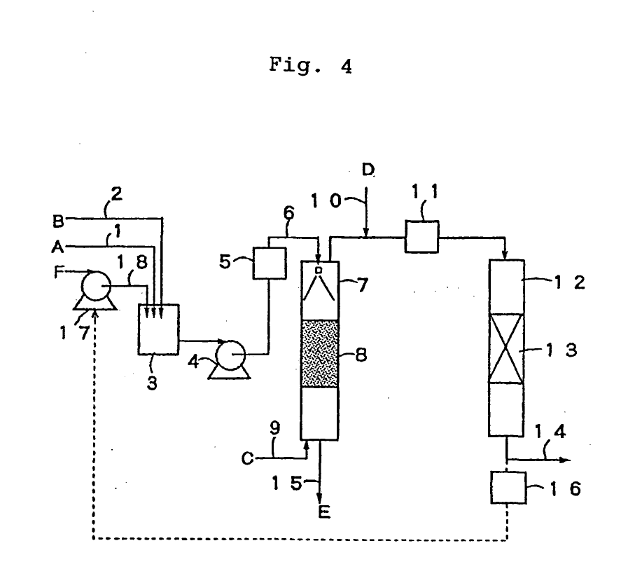

FIG. 4 shows the same apparatus (device system) as shown in FIG. 1 with the exception that the apparatus is planed to adjust the concentration of NH₃ in an NH₃-containing effluent instead of adjusting the amount of an NH₃-containing effluent to be supplied as described in Example 1 with reference to FIG. 1, and thus pump 17 for supplying water F into tank 3 responding to the NOx concentration transmitted from NOx meter 16 is provided.

In the apparatus shown in FIG. 4, effluent A and alkali B are supplied into tank 3 through pipe 1 and pipe 2, respectively, water F is also supplied into tank 3 through pipe 18 with pump 17, when necessary, and they are fed to pre-heater 5 with pump 4 after mixed in tank 3. The effluent A preheated up to about 150° C. with pre-heater 5 is supplied to a top portion of stripping tower 7 through pipe 6. Within stripping tower 7 is placed packing material 8, and steam C (including air) supplied as a carrier gas through pipe 9 connected to a bottom portion of the tower rises through stripping tower 7 while efficiently contacting with effluent A in the tower to obtain a gas containing ammonia at a high concentration.

The concentration of NH₃ in the gas thus obtained is a few thousands to a few tens of thousands ppm. The gas obtained is introduced into catalyst tower 12 after diluted with air D supplied through pipe 10 when necessary and preheated up to a prescribed temperature with pre-heater 11 according to circumstances.

The ammonia stripped and contained in the gas is oxidized to decompose into N₂ and H₂O on catalyst layer 13 and then discharged through pipe 14 into the atmosphere. A part of the gas resulted in the NH₃ decomposition is fed to NOx meter 16 and the concentration of NOx in the gas is determined therewith. Responding to the value determined by NOx meter 16, the flow rate of water F supplied to tank 3 with pump 17 is varied to adjust the concentration of NH₃ in an NH₃-containing effluent. From pipe 15 connected to a bottom portion of stripping tower 7, effluent E resulted by removing ammonia from effluent A is discharged.

### THIRD EMBODIMENT OF THE PRESENT INVENTION

FIG. 5 shows the same apparatus (device system) as shown in FIG. 1 with the exception that the apparatus is planed to adjust the flow rate of an NH₃-containing gas to be contacted with a catalyst instead of adjusting the amount of an NH₃-containing effluent to be supplied as conducted in the apparatus as shown in FIG. 1 and thus regulating valve 19 for supplying air D into the gas subjected to the NH₃ stripping, responding to the NOx concentration transmitted from NOx meter 16, is provided.

In the apparatus shown in FIG. 5, the ammonia stripped and contained in the gas is oxidized to decompose into N₂ and H₂O on catalyst layer 13 and then discharged through pipe 14 into the atmosphere. A part of the gas resulted in the NH₃ decomposition is fed to NOx meter 16 and the concentration NOx in the gas is determined therewith. Responding to the value determined by NOx meter 16, the flow rate of air D supplied through pipe 10 is adjusted with regulating valve 19.

### FOURTH EMBODIMENT OF THE PRESENT INVENTION

FIG. 6 shows an apparatus (device system) in which the concentration of NOx in the gas at the outlet of a catalyst tower is adjusted by circulating a part of the gas.

In the apparatus, a part of gas G discharged from a catalyst tower 12 wherein the NH₃ contained in the gas is decomposed into N₂ and H₂O with NH₃ decomposing catalyst layer 13 is fed to NOx meter 16 and the concentration of NOx in the gas is determined therewith. Another part of the discharged gas is returned to stripping tower 7 with fan 21 through pipe 20, after the temperature of the gas was raised with pre-heater 22 according to circumstances. Responding to the value determined with NOx meter 16, the flow rate of gas G to be returned to stripping tower 7 is controlled with regulating valve 24. Remaining part of the gas G is discharged outside the system through pipe 23 installed between fan 21 and pre-heater 22. From pipe 15 connected to a bottom portion of stripping tower 7, effluent E resulted by removing ammonia from effluent A is discharged. At this time, it is desirable to control the concentration of oxygen in the gas flowing through either pipe.

### FIFTH EMBODIMENT OF THE PRESENT INVENTION

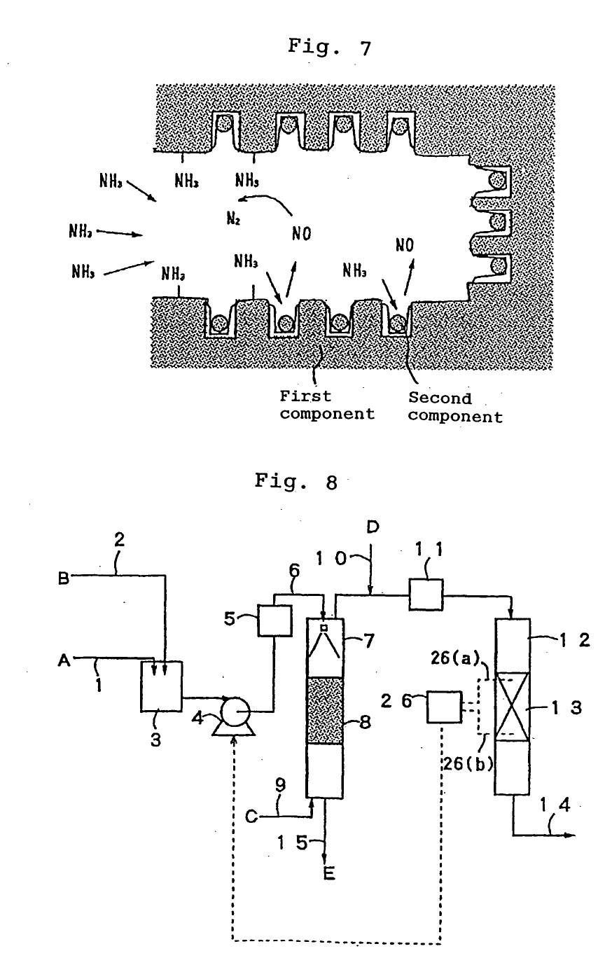

FIG. 8 shows the same apparatus (device system) as shown in FIG. 1 with the exception that the apparatus is planed to adjust the flow rate of effluent A to be supplied to stripping tower 7 responding to the difference in the determined values of temperature between plural measuring points in catalyst layer 13 instead of adjusting the amount of an NH₃-containing effluent to be supplied in the apparatus shown in FIG. 1.

In the apparatus shown in FIG. 8, temperature sensors 26(a), and 26(b) of device 26 for measuring temperature are provided at two points within catalyst layer 13, and the flow rate of effluent A supplied to a top portion of stripping tower 7 with pump 4 is adjusted responding to the difference in the values of the temperature within catalyst layer 13 determined by the temperature sensors 26(a) and 26(b). Although the temperature is determined at two points in catalyst layer 13 in the apparatus shown in FIG. 8, the temperature may be determined at three or more points.

Next, the examples in which a catalyst of the present invention was applied in the apparatus (device system) as shown in FIG. 8 are described.

### EXAMPLE 3

A test for treating an effluent was conducted by using the same catalyst as used in Example 1 and the apparatus as shown in FIG. 8 under the conditions shown in Table 1.

However, when the difference in the temperatures determined by temperature sensors 26(a) and 26(b), respectively, exceeded 10° C., the flow of effluent A to be supplied to a top portion of stripping tower 7 with pump 4 was once stopped; when the difference in the temperatures was 5 to 10° C., effluent A in the amount defined according to the following equation was flowed; and when the difference in the temperatures was smaller than 5° C., the flow rate of effluent A was adjusted to 1.6 L/h (shown in Table 1).
F=(10−ΔT)×0.32
wherein F is flow rate (L/h) and ΔT is the difference in temperatures.

The results indicating the relation between the concentration of NOx in the gas at the outlet of a catalyst tower and the time elapsed after the operation of the apparatus was started and obtained in this test are shown by curve (a) in FIG. 9.

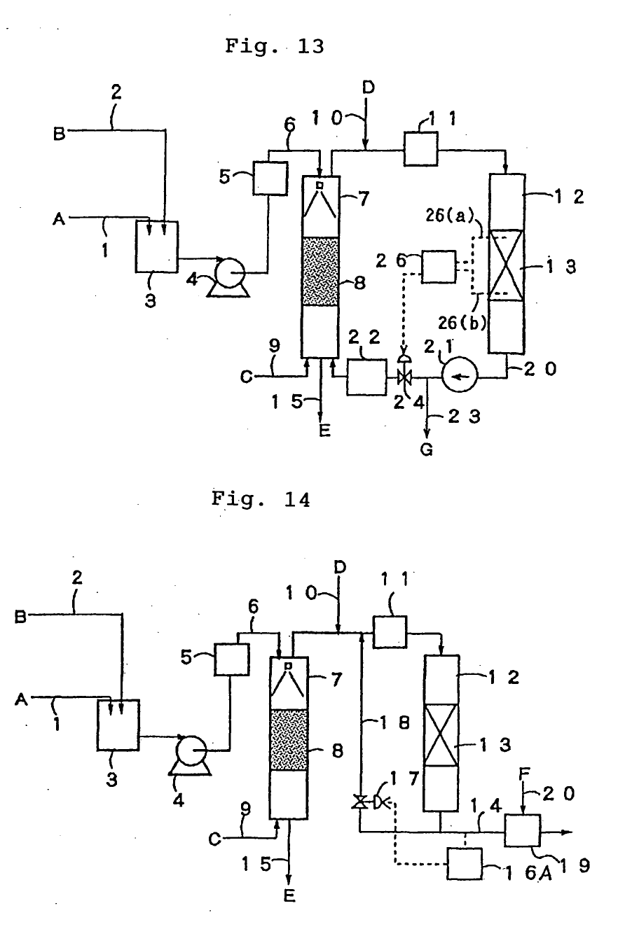

Further, the results obtained in the Comparative Example 1 described above in which a test for treating an effluent was conducted by using the apparatus as shown in FIG. 14 under the same conditions as used in Example 3 and indicated in Table 1 are shown by curve (b) in FIG. 9.

From FIG. 9, it can be understood that the concentration of NOx in the gas at the outlet of a catalyst tower at the time when the operation of the apparatus was started in Example 3 is considerably low compared with the Comparative Example 1.

### EXAMPLE 4

A test for treating an effluent in case the concentration of NH₄⁺ in the effluent is suddenly changed was conducted by using the same catalyst and apparatus as used in Example 3.

In this connection, the control of the flow rate of effluent A to be supplied with pump 4 to a top portion of stripping tower 7 responding to the difference in the temperatures determined by temperature sensors 26(a) and 26(b) of temperature measuring device 26 was conducted in the same way as in Example 3.

The relation between the concentration of NOx in the gas at the outlet of a catalyst tower and the time elapsed after the operation of the apparatus was started in this test is shown by curve (a) in FIG. 10.

### COMPARATIVE EXAMPLE 3

A test for treating an effluent was conducted by using the same apparatus as in Comparative Example 1 under the same conditions as in Example 4. The results thus obtained are shown by curve (b) in FIG. 10.

From FIG. 10, it can be understood that the concentration of NOx in the gas at the outlet of a catalyst tower when the concentration of NH₄⁺ in the effluent is suddenly changed in Example 4 is considerably low compared with Comparative Example 3.

### SIXTH EMBODIMENT OF THE PRESENT INVENTION

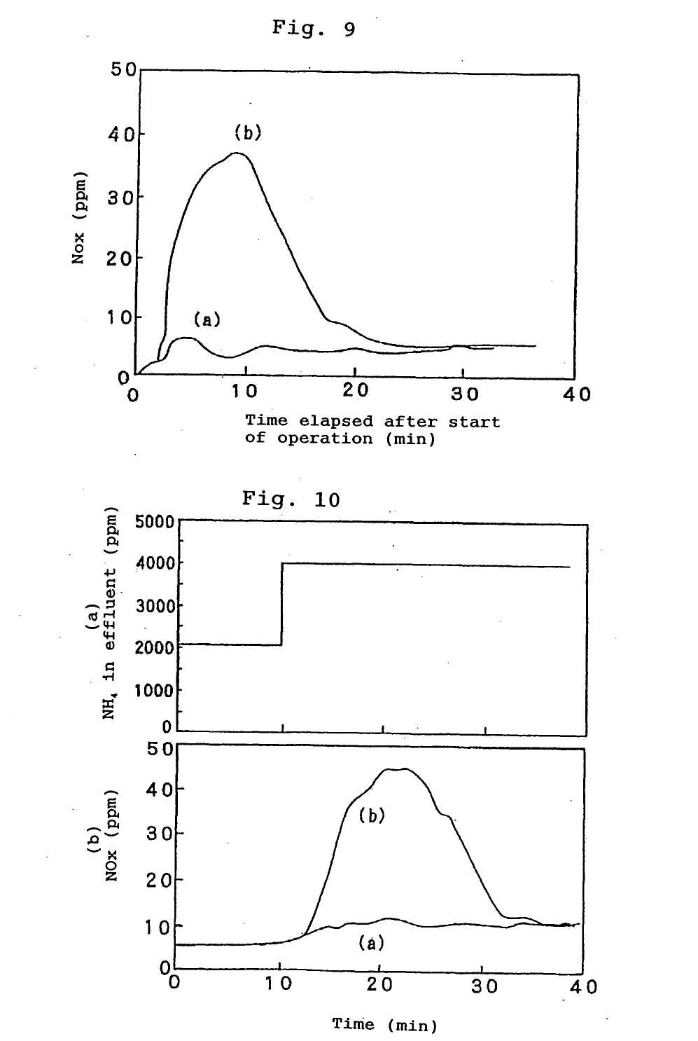

The apparatus (device system) shown in FIG. 11 is the same as in FIG. 8 with the exception that the apparatus is planed to adjust the concentration of NH₃ in an NH₃-containing effluent to be supplied instead of adjusting the flow rate of NH₃-containing effluent A to be supplied to stripping tower 7 in the apparatus shown in FIG. 8.

In the apparatus of FIG. 11, the ammonia stripped and contained in the gas is oxidized to decompose into N₂ and H₂O on catalyst layer 13 and then discharged through pipe 14 into the atmosphere. The temperatures at plural points separated within catalyst layer 13 are determined with temperature measuring device 26 provided with temperature sensors 26(a) and 26(b), and the flow rate of water F supplied to tank 3 through pump 17 is varied responding to the difference of the determined values of temperature to adjust the concentration of NH₃ in the effluent supplied through pump 4 to a top portion of stripping tower 7. From pipe 15 connected to a bottom portion of stripping tower 7, effluent E resulted by removing ammonia from effluent A is discharged.

### SEVENTH EMBODIMENT OF THE PRESENT INVENTION

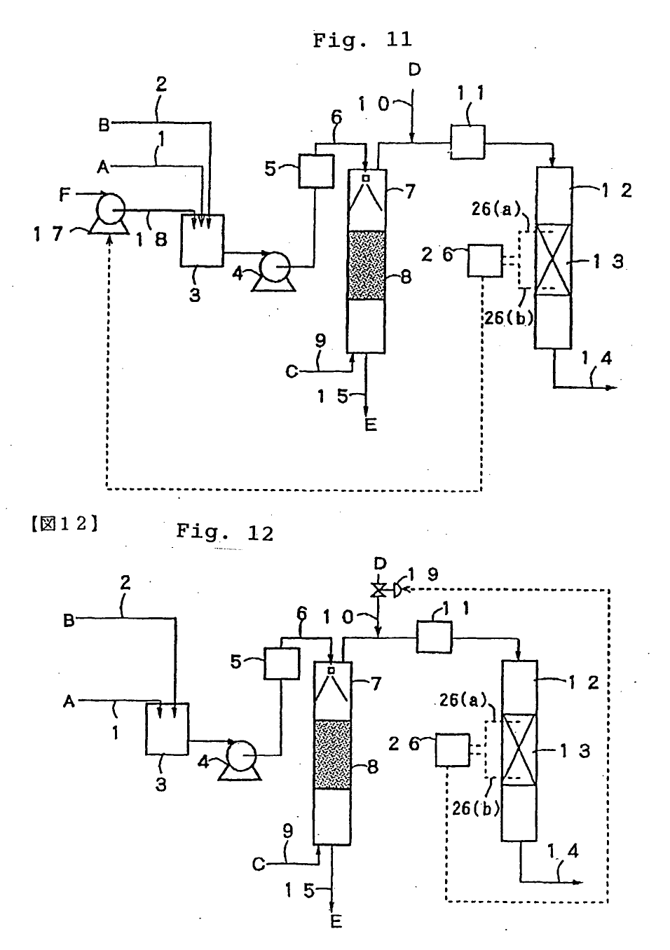

The apparatus (device system) shown in FIG. 12 is the same as in FIG. 8 with the exception that the apparatus is planed to adjust the flow rate of an NH₃-containing gas to be contacted with catalyst layer 13 instead of adjusting the flow rate of an NH₃-containing effluent supplied to stripping tower 7 in the apparatus shown in FIG. 8.

In the apparatus of FIG. 12, the ammonia stripped and contained in the gas is oxidized to decompose into N₂ and H₂O on catalyst layer 13 and then discharged through pipe 14 into the atmosphere. Temperatures at plural points within catalyst layer 13 are determined with temperature measuring device 26 provided with temperature sensors 26(a) and 26(b), and the flow rate of air D to be supplied through pipe 10 is controlled with regulating valve 19 responding to the difference of the determined values of temperature. From pipe 15 connected to a bottom portion of stripping tower 7, effluent E resulted by removing ammonia from effluent A is discharged.

### EIGHTH EMBODIMENT OF THE PRESENT INVENTION

The apparatus shown in FIG. 13 is the same as in FIG. 8 with the exception that the apparatus is planed to adjust the concentration of NOx in the gas (gas G) at the outlet of catalyst tower 13 by circulating a part of gas G to stripping tower 7 instead of adjusting the flow rate of an NH₃-containing effluent supplied to stripping tower 7 in the apparatus shown in FIG. 8.

In the apparatus of FIG. 13, the gas containing the stripped ammonia is contacted with catalyst layer 13 to decompose the ammonia into N₂ and H₂O. A part of gas G NH₃ previously contained in which was decomposed into N₂ and H₂O with catalyst layer 13 is circulated to stripping tower 7 with fan 21 through pipe 20, after the temperature of the gas was raised with pre-heater 22 according to circumstances. Temperatures at plural points within catalyst layer 13 are determined with temperature measuring device 26 provided with temperature sensors 26(a) and 26(b), and the flow rate of gas G to be circulated to stripping tower 7 is controlled with regulating valve 24 responding to the difference of the determined values of temperature. Remaining part of gas G is discharged outside the system through pipe 23 installed between fan 21 and pre-heater 22. From pipe 15 connected to a bottom portion of stripping tower 7, effluent E resulted by removing ammonia from effluent A is discharged.

### NINTH EMBODIMENT OF THE PRESENT INVENTION

FIG. 14 shows the same apparatus (device system) used for treating an NH₃-containing effluent as shown in FIG. 1 with the exception that device 16A for determining the concentration of N₂O is used in place of a device for determining the concentration of NOx (NOx meter 16) used in the apparatus shown in FIG. 1.

In the apparatus shown in FIG. 14, effluent A discharged from a thermal power plant and containing an ammonia nitrogen, and alkali B are supplied to tank 3 through pipe 1 and pipe 2, respectively, mixed in tank 3, and then fed to pre-heater 5 with pump 5. The effluent A preheated with pre-heater 5 up to about 100° C. is supplied to a top portion of stripping tower 7 through pipe 6.

Within stripping tower 7 is placed packing material 8, steam C (including air) supplied through pipe 9 connected to a bottom portion of the tower as a carrier gas rises through the tower while efficiently contacting with effluent A in the tower to obtain a gas containing ammonia at a high concentration. The concentration of NH₃ in the gas obtained in stripping tower 7 is a few thousands to a few tens of thousands ppm.

The gas thus obtained is introduced into catalyst tower 12 after diluted with air D supplied through pipe 10 when necessary and preheated with pre-heater 11 up to a prescribed temperature according to circumstances. The ammonia stripped and contained in the gas is oxidized to decompose into N₂ and H₂O on catalyst layer 13 having a relatively low power of oxidizing NH₃ and then discharged into the atmosphere.

A part of the gas discharged from catalyst tower 12 is circulated to pre-heater 11 through pipe 18 and then introduced again into catalyst tower 12 to oxidatively decompose ammonia contained in the gas. The amount of the gas to be circulated is controlled by the opening of regulating valve 17 responding to the determined value of the concentration of N₂O contained in the gas in pipe 14 determined by using device 16A for measuring the concentration of N₂O.

Further, the ammonia contained in the gas to be discharged through pipe 14 into the atmosphere is absorbed in device 19 for removing ammonia, specifically by acidic absorbing liquid F supplied through pipe 20, when necessary. It is possible to return the ammonia absorbed by absorbing liquid F into tank 3. From pipe 15 connected to a bottom portion of stripping tower 7, effluent E resulted by removing ammonia from effluent A is discharged.

The catalyst in catalyst layer 13 comprises a first component having an activity of reducing nitrogen oxides with ammonia and a second component having an activity of forming nitrogen oxides (NOx) from ammonia. Reaction temperature in catalyst layer 13 at this time is 250 to 500° C. and preferably 350 to 450° C.

An example in which a catalyst of the present invention was applied in the apparatus (device system) as shown in FIG. 14 is described below.

### EXAMPLE 5

Ammonium paratungstate ((NH₄)₁₀H₁₀.W₁₂O₄₆.6H₂O) in an amount of 2.5 kg and 2.33 kg of ammonium metavanadate were added to 67 kg of a slurry of metatitanic acid (TiO₂ content: 30 wt %, SO₄ content: 8 wt %) and mixed by using a kneader. The paste thus obtained was granulated, dried, and then calcined at 550° C. for 2 hours. The granules thus obtained were ground to obtain powders as a first component of a catalyst. The powders had a composition of Ti/W/V=91/5/4 (ratio of atoms).

On the other hand, 500 g of fine powders of silica (produced by Tomita Pharmaceuticals Co., Ltd.; trade name: Micon F) was added to 1 L of 1.33×10² wt % of chloroplatinic acid (H₂[PtCl₆].6H₂O), evaporated to dryness on a sand bath, and then calcined at 500° C. for 2 hours in the air to prepare 0.01 wt % Pt.SiO₂ powders as a second component of the catalyst.

Next, 5.3 kg of silica.alumina type inorganic fibers and 17 kg of water were added to the mixture of 20 kg of the first component and 40.1 g of the second component, and kneaded to obtain a catalyst paste. Separately, a net-like product made of E glass fibers was impregnated with a slurry containing a titania, silica sol and polyvinyl alcohol, dried at 150° C., and cut into plural sheets to prepare catalyst substrates. Between two of the catalyst substrates (sheets) was held the catalyst paste described above and they were passed through press rollers to roll, thereby obtaining a plate-like product. After the plate-like product was air-dried in the atmosphere for 12 hours, it was calcined at 500° C. for 2 hours to obtain an NH₃ decomposing catalyst A having a denitrating function.

In the catalyst thus obtained, the ratio of the second component to the first component (the second component/the first component) was 0.2/99.8. Pt content corresponded to 1 ppm excluding the catalyst substrates and inorganic fibers.

A test for treating an effluent was conducted by using the catalyst obtained in this example and the apparatus as shown in FIG. 14 under the conditions shown in Table 2. The relation between the concentrations of NOx and N₂O in the gas at the outlet of a catalyst tower and the flow rate of the gas at the inlet of catalyst layer 13 is shown in FIG. 15. In this example, the concentration of the N₂O was reduced while maintaining the concentration of the NOx at about the same level by increasing the flow rate of the gas at the inlet of catalyst layer 13.

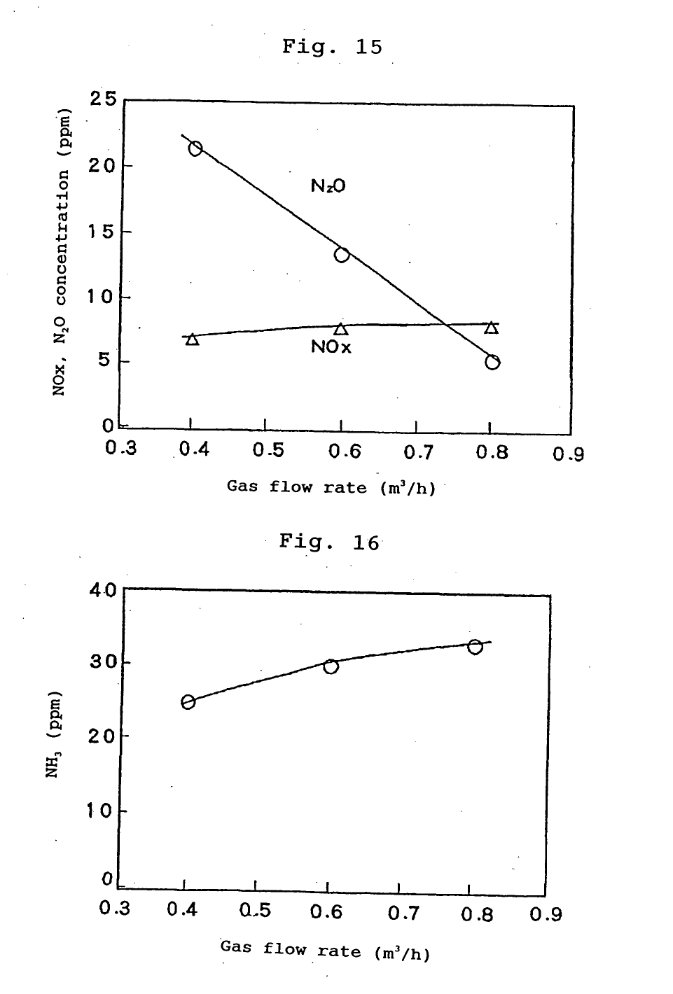

Besides, the relation between the concentration of NH₃ in the gas at the outlet of catalyst layer 13 (catalyst tower 12) and the flow rate of the gas at the inlet of catalyst layer 13 is shown in FIG. 16. When the flow rate of the gas at the inlet of catalyst layer 13 was increased, the concentration of NH₃ in the gas at the outlet of catalyst 13 was increased. However, NH₃ decomposition ratio in catalyst layer 13 was higher than 99% and the amounts of utilities such as heat sources and chemicals necessary for the treatment were scarcely increased even when the unreacted NH₃ was absorbed by an absorbing liquid, returned to tank 3, and then subjected to a treatment again.

TABLE 2

| Item | Condition | |
|---|---|---|
| Rate of treating effluent | 1.6 | L/h |
| Amount of NH₄⁺ in effluent | 2,000 | mg/L |
| Gas flow rate at inlet of | 0.4 to 0.8 | m³/h |
| catalyst layer | | |
| Gas composition | NH₃: 5,000 to 10,000 | |
| | ppm | |
| | H₂O: 28% | |
| | Air: the remainder | |
| Temperature | 400° | C. |
| Areal velocity | 5 to 10 | m/h |

### TENTH EMBODIMENT OF THE PRESENT INVENTION

While the apparatus described in the ninth embodiment of the present invention described above is excellent in cost efficiency since the amount of the energy necessary for heating a gas can be reduced, the same effects as in the ninth embodiment can be obtained even in the tenth embodiment of the present invention described below.

FIG. 17 shows the same apparatus (device system) as shown in FIG. 14 with the exception that the apparatus is planed to adjust the flow rate of air D supplied through pipe to the gas discharged from stripping tower 7 with regulating valve 21 instead of adjusting the flow rate of the post-treatment gas to be circulated through pipe 18 in the apparatus as shown in FIG. 14.

The ammonia stripped and contained in the gas is oxidized to decompose into N_{2 and H}₂O on catalyst layer 13 and then discharged through pipe 14 into the atmosphere: The concentration of N₂O in the gas at the outlet of catalyst tower 12 is determined with device 16A for measuring the concentration of N₂O installed at the outlet of catalyst tower 12, and the flow rate of air D supplied through pipe 10 is controlled with regulating valve 21 responding to the determined value of the N₂O concentration.

### ELEVENTH EMBODIMENT OF THE INVENTION

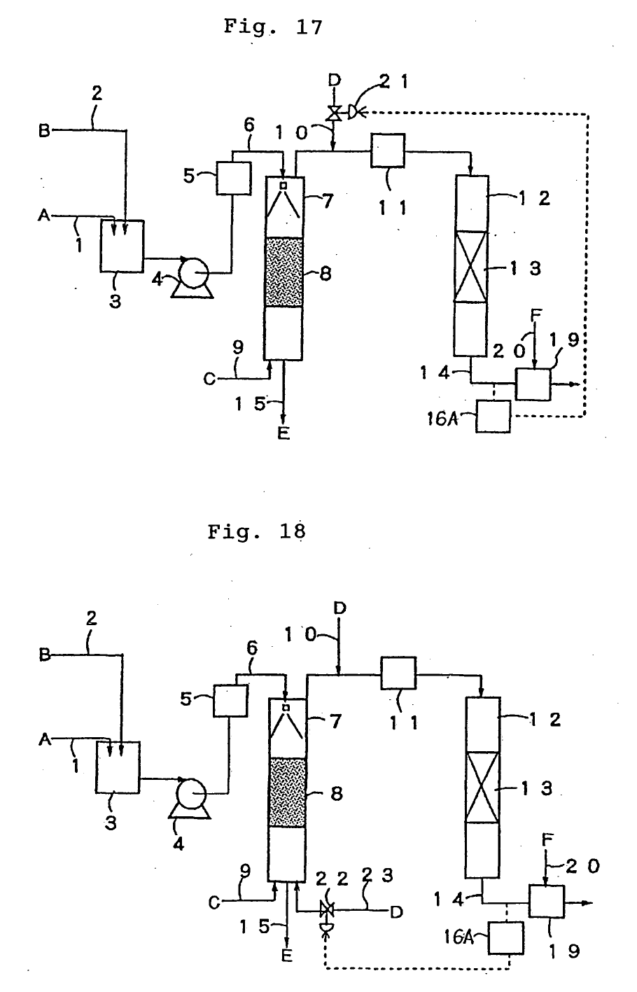

FIG. 18 shows the same apparatus (device system) as in FIG. 14 with the exception that the apparatus is planed to adjust the flow rate of air D supplied through pipe 23 to a bottom portion of stripping tower 7 with regulating valve 22 instead of adjusting the flow rate of the post-treatment gas to be circulated through pipe 18 in the apparatus shown in FIG. 14.

The concentration of N₂O in the gas at the outlet of catalyst tower 12 is determined with device 16A for measuring the concentration of N₂O installed at the outlet of catalyst tower 12, and the flow rate of air D supplied through pipe 23 to stripping tower 7 is controlled with regulating valve 22 responding to the determined value of the N₂O concentration.

### TWELFTH EMBODIMENT OF THE PRESENT INVENTION

FIG. 19 shows the same apparatus (device system) as in FIG. 14 with the exception that two catalyst towers 12A and 12B are installed in parallel for the purpose of adjusting the volume of catalyst layers 13.

An ammonia-containing gas is introduced into catalyst tower 12A or/and 12B after diluted with air D supplied through pipe 10 when necessary and preheated with pre-heater 11 up to a prescribed temperature according to circumstances. The ammonia stripped and contained in the gas is oxidized to decompose into N₂ and H₂O on catalyst layer 13A or/and 13B, and then discharged through pipe 14 into the atmosphere. Switching of the catalyst tower, into which an ammonia-containing gas is introduced, back and forth between catalyst tower 12A and 12B is performed responding to the determination of the concentration of N₂O in the gas at the outlet of the catalyst towers.

The concentration of N₂O in the gas at the outlet of the catalyst towers is determined with device 16A for measuring the concentration of N₂O installed at the outlet of the catalyst towers, and the switching of the catalyst towers is performed with switching valves 24A and 24B responding to the determined value of the concentration of N₂O. That is, when the determined value of the concentration of the N₂O rose due to the oxidative decomposition of ammonia gas on catalyst layer 13A or 13B, both catalyst layers 13A and 13B are used.

### THIRTEENTH EMBODIMENT OF THE PRESENT INVENTION

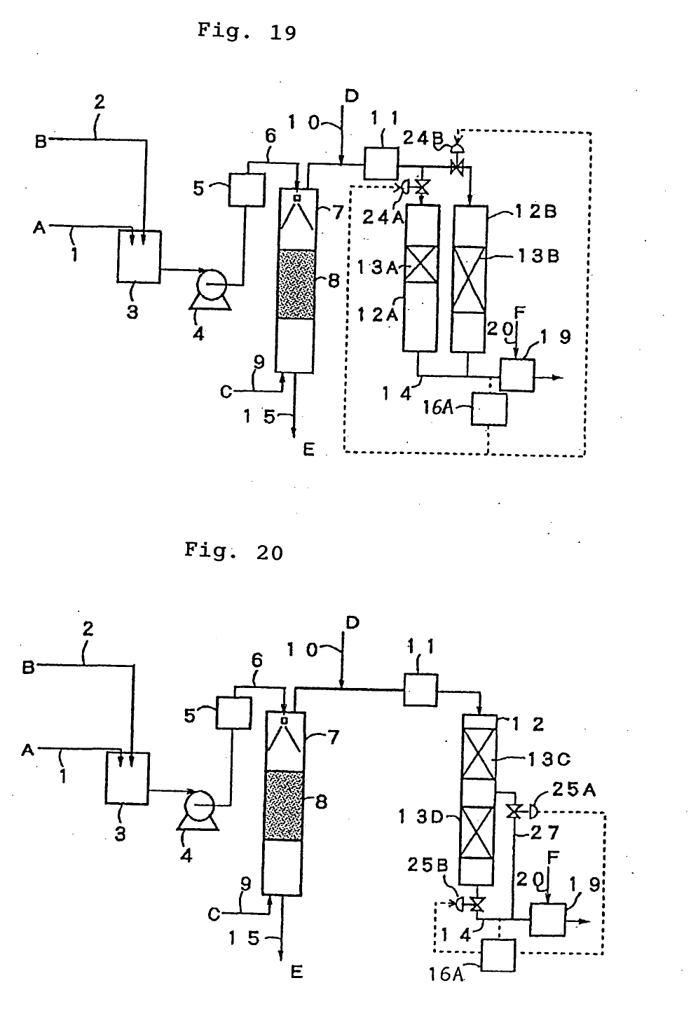

FIG. 20 shows the same apparatus as in FIG. 14 with the exception that the apparatus is planed to adjust the volume of catalyst layer 13 contacting with a gas within one catalyst tower 12.

In the catalyst tower 12, two catalyst layers, 13C and 13D are arranged along the direction of the gas flow with a space in series, and one end of pipe 27 for taking a circuitous route around the lower catalyst layer 13D is connected to the catalyst tower at a position between catalyst layer 13C and catalyst layer 13D. Pipe 27 is provided with switching valve 25A, and the other end of pipe 27 is connected to pipe 14 connected to a bottom portion of catalyst tower 12.

The ammonia stripped and contained in the gas is oxidatively decomposed on catalyst layer 13C, further oxidized to decompose into N₂ and H₂O on catalyst layer 13D according to circumstances, and then discharged through pipe 14 into the atmosphere.

Switching between an operation in which an ammonia-containing gas is contacted only with catalyst layer 13C and another operation in which the gas is contacted further with catalyst layer D is performed by changing the condition of switching valve 25A provided to pipe 27 and changing the condition of switching valve 25B provided to pipe 14 responding to the value of the concentration of N₂O determined with device 16A used for measuring N₂O concentration and installed at the outlet of catalyst tower 12. That is, when the determined value of the concentration of N₂O rose due to the oxidative decomposition of ammonia on catalyst layer 13C or 13D, both catalyst layers 13C and 13D are used.

According to the embodiments using one of the apparatuses as shown in FIGS. 14 to 20, a problem that when the concentration of NH₃ in the gas after subjected to a treatment in a catalyst tower was lowered, the concentration of NOx and the concentration of N₂O in the gas at the outlet of a catalyst tower become slightly high is resolved, and the amount of hazardous substances produced can considerably be reduced.

Industrial Applicability

According to the present invention, a problem that the concentration of NOx and the concentration of N₂O in the gas at the outlet of a catalyst tower become high at the time when the operation of an apparatus for treating an NH₃-containing effluent was started or when the concentration of NH₃ in the gas to be treated was varied disappears, and the amount of hazardous substances produced can be reduced.

1. A method for treating an ammonia-containing effluent comprising a stripping step in which the ammonia (NH₃) contained in the NH₃-containing effluent is transferred from the effluent into a gas phase by contacting the effluent with a carrier gas, a step for decomposing the NH₃ into nitrogen and water by contacting the gas resulted at the stripping step and containing the NH₃ with a catalyst used for decomposing NH₃, at a prescribed temperature, a step for determining the concentration of the nitrogen oxides (NOx) contained in the gas resulted at the NH₃ decomposing step, and a step for adjusting one or more of the following parameters:
(a) the amount of the NH₃-containing effluent to be supplied,
(b) the concentration of the NH₃ contained in the NH₃-containing effluent, and
(c) the flow rate of the NH₃-containing gas to be contacted with the catalyst
so that the determined value of the concentration of the NOx becomes lower than a prescribed value.

2. The method for treating an NH₃-containing effluent according to claim 1 wherein the temperatures of the layer of the catalyst at plural points located along the direction of the gas flow at the NH₃ decomposing step are determined instead of determining the concentration of the NOx contained in the gas resulted at the NH₃ decomposing step, and one or more of the parameters (a), (b), and (c) defined in claim 1 are adjusted responding to the difference between the determined temperatures instead of the concentration of the NOx.

3. The method for treating an NH₃-containing effluent according to claim 1 or 2 wherein the catalyst used for decomposing NH₃ comprises a first component having an activity of reducing NOx with NH₃ and a second component having an activity of forming NOx from NH₃.

4. The method for treating an NH₃-containing effluent according to claim 1 or 2 wherein the catalyst used for decomposing NH₃ comprises, as a first component, an oxide of titanium (Ti) and an oxide of one or more elements selected from the group consisting of tungsten (W), vanadium (V), and molybdenum (Mo), and, as a second component, a silica, zeolite, and/or alumina having one or more noble metals selected from the group consisting of platinum (Pt), iridium (Ir), rhodium (Rh), and palladium (Pd) supported thereon.

5. The method for treating an NH₃-containing effluent according to claim 1 wherein the catalyst used for decomposing NH₃ is a zeolite or comprises, as a main component, a zeolite.

6. The method for treating an NH₃-containing effluent according to claim 1 wherein the method further comprises a step for removing ammonia from a part of the gas resulted at the NH₃ decomposing step after the part of the gas was discharged outside the system.

7. A method for treating an NH₃-containing effluent comprising a stripping step in which the NH₃ contained in the NH₃-containing effluent is transferred from the effluent into a gas phase by contacting the effluent with a carrier gas, a step for decomposing the NH₃ into nitrogen and water by contacting the gas resulted at the stripping step and containing the NH₃ with a catalyst used for decomposing NH₃, at a prescribed temperature, a step for determining the concentration of the N₂O contained in the gas resulted at the NH₃ decomposing step, and a step for adjusting the flow rate of the gas in the layer of the catalyst or adjusting the contact time of the gas with the catalyst in the layer so that the determined value of the concentration of the N₂O becomes lower than a prescribed value.

8. The method for treating an NH₃-containing effluent according to claim 7 wherein, as a method for adjusting the flow rate of the gas in the catalyst layer, one of the following methods is used:
(e) a method in which the flow rate of the carrier gas at the step for transferring the NH₃ contained in the NH₃-containing effluent into the gas phase is adjusted,
(f) a method in which a gas such as air is added to the NH₃-containing gas resulted at the step for transferring the NH₃ contained in the NH₃-containing effluent into the gas phase, and
(g) a method in which a part of the gas resulted at the NH₃ decomposing step is circulated to the catalyst layer.

9. The method for treating an NH₃-containing effluent according to claim 8 wherein the temperatures of the layer of the catalyst at plural points located along the direction of the gas flow at the NH₃ decomposing step are determined instead of determining the concentration of the N₂O contained in the gas resulted at the NH₃ decomposing step, and one or more of the methods (e), (f), and (g) defined in claim 8 are conducted responding to the difference between the determined temperatures instead of the concentration of the N₂O.

10. The method for treating an NH₃-containing effluent according to claim 7 or 8 wherein the catalyst used for decomposing NH₃ comprises a first component having an activity of reducing NOx with NH₃ and a second component having an activity of forming NOx from NH₃.

11. The method for treating an NH₃-containing effluent according to claim 7 or 8 wherein the catalyst used for decomposing NH₃ comprises, as a first component, an oxide of titanium (Ti) and an oxide of one or more elements selected from the group consisting of tungsten (W), vanadium (V), and molybdenum (Mo), and, as a second component, a silica, zeolite, and/or alumina having one or more noble metals selected from the group consisting of platinum (Pt), iridium (Ir), rhodium (Rh), and palladium (Pd) supported thereon.

12. The method for treating an NH₃-containing effluent according to claim 7 or 8 wherein the catalyst used for decomposing NH₃ is a zeolite or comprises, as a main component, a zeolite.

13. The method for treating an NH₃-containing effluent according to claim 7 or 8 wherein the method further comprises a step for removing ammonia from a part of the gas resulted at the NH₃ decomposing step after the part of the gas was discharged outside the system.

14. An apparatus for treating an NH₃-containing effluent comprising a stripping device in which the NH₃ contained in the NH₃-containing effluent is transferred from the effluent into a gas phase by contacting the effluent with a carrier gas, a device for decomposing the NH₃ into nitrogen and water by contacting the gas resulted in the stripping device and containing the NH₃ with a catalyst used for decomposing NH₃, at a prescribed temperature, a device for determining the concentration of the nitrogen oxides (NOx) contained in the gas resulted in the NH₃ decomposing device, and a device for adjusting one or more of the following parameters:
(a) the amount of the NH₃-containing effluent to be supplied,
(b) the concentration of the NH₃ contained in the NH₃-containing effluent, and
(c) the flow rate of the NH₃-containing gas to be contacted with the catalyst
so that the determined value of the concentration of the NOx becomes lower than a prescribed value.

15. An apparatus for treating an NH₃-containing effluent comprising a stripping device in which the NH₃ contained in the NH₃-containing effluent is transferred from the effluent into a gas phase by contacting the effluent with a carrier gas, a device for decomposing the NH₃ into nitrogen and water by contacting the gas resulted in the stripping device and containing the NH₃ with a catalyst used for decomposing NH₃, at a prescribed temperature, a device for determining the concentration of the N₂O contained in the gas resulted in the NH₃ decomposing device, and a device for adjusting the flow rate of the gas in the layer of the catalyst or adjusting the contact time of the gas with the catalyst in the layer so that the determined value of the-concentration of the N₂O becomes lower than a prescribed value.
